(19) United States
(12) Patent Application Publication
(10) Pub. No.: US 2026/0286250 A1
(43) Pub. Date: Sep. 24, 2026

(54) LIQUID LAUNDRY DETERGENT WITH SYNERGISTIC LOW TEMPERATURE DETERGENCY BLEND

(71) Applicant: DOW GLOBAL TECHNOLOGIES LLC, Midland, MI (US)

(72) Inventors: Yang Zhang, Shanghai (CN); Cheng Shen, Shanghai (CN)

(21) Appl. No.: 19/168,483

(22) PCT Filed: Apr. 13, 2023
(86) PCT No.: PCT/CN2023/087982

§ 371 Date: Sep. 24, 2025

(51) Int. Cl. C11D 1/83; C11D 1/14; C11D 1/22; C11D 1/722; C11D 3/37

(52) U.S. Cl. CPC C11D 1/8305; C11D 3/3707; C11D 1/146; C11D 1/22; C11D 1/722

(57) ABSTRACT

A liquid laundry detergent formulation is provided, comprising a synergistic low temperature detergency blend comprising: (a) anionic surfactant; (b) nonionic surfactant selected from the group of nonionic surfactants having formula (I) R⁶—O-(EO)ₓ-(AO)_{y}-(EO)_{z}-H (I) wherein R⁶ is linear C₈₋₁₈ alkyl group; wherein AO is oxyalkylene group with 3-5 carbon atoms; wherein x is 2-4; wherein y is 6-25; wherein z is 1-50; and (c) cleaning booster of Formula (II), wherein each R¹ is chain of Formula (III), wherein each R² is independently selected from C₁₋₈ alkyl group and chain of Formula (III); wherein R³ and R⁴ are aliphatic C₃₋₁₂ CN alkanediyl group; wherein each R⁵ is independently selected from hydrogen and —C₁₋₄ alkyl group; wherein n is 0-8; wherein m is 5-50; and wherein the cleaning booster has weight average molecular weight of ≤10,000 Daltons; and wherein the liquid laundry detergent formulation has pH of 6.5-11.

The present invention relates to a liquid laundry detergent formulation for low temperature household use. In particular, the present invention relates to a liquid laundry detergent formulation, comprising a synergistic low temperature detergency blend comprising: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof; (b) a nonionic surfactant selected from the group of nonionic surfactants having formula (I)

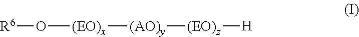

wherein R⁶ is a linear C₈₋₁₈ alkyl group; wherein AO is an oxyalkylene group with 3 to 5 carbon atoms; wherein x is 2 to 4; wherein y is 6 to 25; wherein z is 1 to 50; and (c) a cleaning booster of Formula (II)

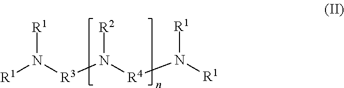

wherein each R¹ is independently a chain of Formula (III)

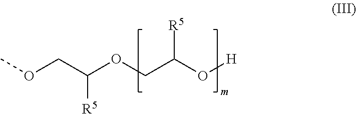

wherein each R² is independently selected from the group consisting of a C₁₋₈ alkyl group and a chain of Formula (III); wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein m is an average of 5 to 50; and wherein the cleaning booster has a weight average molecular weight of ≤10,000 Daltons; and wherein the liquid laundry detergent formulation has a pH of 6.5 to 11.

The efficiency of fabric cleaning is dependent on the wash liquid temperature. Lowering of the wash liquid temperature usually leads to poorer soil removal. However, cleaning fabric articles under low temperature conditions is inevitable during the winter months in many geographic regions. That is, many consumers do not have a hot water supply in their houses and municipal water supplies can sometimes be at temperatures of 10° C. when fed into washing machines. In addition, consumers are increasingly choosing to do laundry without heating to reduce energy consumption and carbon emissions. Notwithstanding the temperature of the wash water, consumers expect their laundry detergent to perform consistently.

Accordingly, there is a continuing need for laundry detergent formulations that exhibit effective detergency for cleaning water temperatures at ≤15° C. (preferably, ≤10° C.).

The present invention provides a liquid laundry detergent formulation, comprising a synergistic low temperature detergency blend comprising: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof; (b) a nonionic surfactant selected from the group of nonionic surfactants having formula (I)

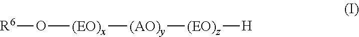

wherein R⁶ is a linear C₈₋₁₈ alkyl group; wherein AO is an oxyalkylene group with 3 to 5 carbon atoms; wherein x is 2 to 4; wherein y is 6 to 25; wherein z is 1 to 50; and (c) a cleaning booster of Formula (II)

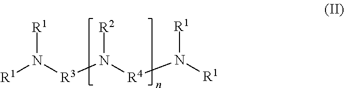

wherein each R¹ is independently a chain of Formula (III)

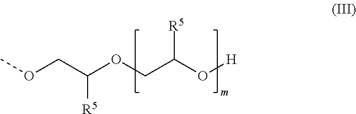

wherein each R² is independently selected from the group consisting of a C₁₋₈ alkyl group and a chain of Formula (III); wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein i is an average of 5 to 50; and wherein the cleaning booster has a weight average molecular weight of ≤10,000 Daltons; and wherein the liquid laundry detergent formulation has a pH of 6.5 to 11.

The present invention provides a liquid laundry detergent formulation, comprising a synergistic low temperature detergency blend comprising: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof: (b) a nonionic surfactant selected from the group of nonionic surfactants having formula (I); wherein R⁶ is a linear C₈₋₁₈ alkyl group; wherein AO is an oxyalkylene group with 3 to 5 carbon atoms; wherein x is 2 to 4; wherein y is 6 to 25; wherein z is 1 to 50; and (c) a cleaning booster of Formula (II); wherein each R¹ is independently a chain of Formula (III); wherein each R² is independently selected from the group consisting of a C₁₋₈ alkyl group and a chain of Formula (III): wherein R³ and R⁴ are independently an aliphatic C₃₋₁₂ alkanediyl group; wherein each R⁸ is independently selected from the group consisting of a hydrogen and a —C₁₋₄ alkyl group; wherein n is an average of 0 to 8; wherein m is an average of 5 to 50; and wherein the cleaning booster has a weight average molecular weight of ≤10,000 Daltons; wherein the liquid laundry detergent formulation has a pH of 6.5 to 11; and wherein the liquid laundry detergent formulation further comprises water.

The present invention provides a liquid laundry detergent formulation, comprising a synergistic low temperature detergency blend comprising: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof; (b) a nonionic surfactant selected from the group of nonionic surfactants having formula (I); wherein R⁶ is a linear C₈₋₁₈ alkyl group; wherein AO is an oxyalkylene group with 3 carbon atoms; wherein x is 2 to 4; wherein y is 6 to 25; wherein z is 1 to 50; and (c) a cleaning booster of Formula (II): wherein each R¹ is independently a chain of Formula (III); wherein each R² is independently selected from the group consisting of a C₁₋₈ alkyl group and a chain of Formula (III): wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein m is an average of 5 to 50; and wherein the cleaning booster has a weight average molecular weight of ≤10,000 Daltons; wherein the liquid laundry detergent formulation has a pH of 6.5 to 11; wherein the liquid laudry detergent formulation further comprises water; and wherein the liquid laundry detergent formulation comprises 5 to 95 wt %, based on weight of the liquid laundry detergent formulation, of the anionic surfactant (a) plus the nonionic surfactant (b).

The present invention provides a liquid laundry detergent formulation, comprising a synergistic low temperature detergency blend comprising: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof; (b) a nonionic surfactant selected from the group of nonionic surfactants having formula (I); wherein R⁶ is a linear C₈₋₁₈ alkyl group; wherein AO is an oxyalkylene group with 3 carbon atoms; wherein x is 2 to 4; wherein y is 6 to 25; wherein z is 1 to 50; and (c) a cleaning booster of Formula (II): wherein each R¹ is independently a chain of Formula (III); wherein each R² is independently selected from the group consisting of a C₁₋₈ alkyl group and a chain of Formula (III); wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein m is an average of 5 to 50; and wherein the cleaning booster has a weight average molecular weight of ≤10,000 Daltons; wherein the liquid laundry detergent formulation has a pH of 6.5 to 11; wherein the liquid laudry detergent formulation further comprises water; wherein the liquid laundry detergent formulation comprises 5 to 95 wt %, based on weight of the liquid laundry detergent formulation, of the anionic surfactant (a) plus the nonionic surfactant (b); and wherein the nonionic surfactant comprises 15 to 60 wt % of the combined weight of the anionic surfactant (a) and the nonionic surfactant (b).

The present invention provides a liquid laundry detergent formulation, comprising a synergistic low temperature detergency blend comprising: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof; (b) a nonionic surfactant selected from the group of nonionic surfactants having formula (I); wherein R⁶ is a linear C₈₋₁₈ alkyl group; wherein AO is an oxyalkylene group with 3 carbon atoms; wherein x is 2 to 4; wherein y is 6 to 25; wherein z is 1 to 50; and (c) a cleaning booster of Formula (II); wherein each R¹ is independently a chain of Formula (III); wherein each R² is independently selected from the group consisting of a C₁₋₈ alkyl group and a chain of Formula (III); wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein m is an average of 5 to 50; and wherein the cleaning booster has a weight average molecular weight of ≤10,000 Daltons; wherein the liquid laundry detergent formulation has a pH of 6.5 to 11; wherein the liquid laudry detergent formulation further comprises water; wherein the liquid laundry detergent formulation comprises 5 to 95 wt %, based on weight of the liquid laundry detergent formulation, of the anionic surfactant (a) plus the nonionic surfactant (b); wherein the nonionic surfactant comprises 15 to 60 wt % of the combined weight of the anionic surfactant (a) and the nonionic surfactant (b); and wherein the liquid laundry detergent formulation further comprises a water miscible organic solvent.

The present invention also provides use of a liquid laundry detergent formulation comprising a synergistic low temperature detergency blend for cleaning fabrics under cold wash conditions; wherein the synergisting low temperature detergency blend comprises: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof; (b) a nonionic surfactant selected from the group of nonionic surfactants having formula (I); wherein R⁶ is a linear C₈₋₁₈ alkyl group; wherein AO is an oxyalkylene group with 3 to 5 carbon atoms; wherein x is 2 to 4; wherein y is 6 to 25; wherein z is 1 to 50; and wherein the nonionic surfactant is selected based on its ability to impart detergency stability to the laundry detergent formulation for cleaning water temperatures ranging from 10 to 30° C.; and (c) a cleaning booster of Formula (II); wherein each R¹ is independently a chain of Formula (III); wherein each R² is independently selected from the group consisting of a C₁₋₈ alkyl group and a chain of Formula (III); wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein m is an average of 5 to 50; and wherein the cleaning booster has a weight average molecular weight of ≤10,000 Daltons; and wherein the liquid laundry detergent formulation has a pH of 6.5 to 11.

The present invention provides a method of washing a fabric article comprising: providing a soiled fabric article; providing a liquid laundry detergent formulation of the present invention; providing a wash water at a temperature of ≤15° C.; and applying the wash water and the liquid laundry detergent formulation to the soiled fabric article to provide a cleaned fabric article.

### DETAILED DESCRIPTION

It has been surprisingly found that aqueous liquid laundry detergents specifically formulated with a combination of a selection of anionic surfactants; a nonionic surfactant having formula (I)

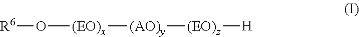

wherein R⁶ is a linear C₈₋₁₈ alkyl group (preferably, a linear C₁₀₋₁₈ alkyl group; more preferably, a linear C₁₂₋₁₄ alkyl group or a linear C₁₆₋₁₈ alkyl group); wherein AO is an oxyalkylene group with 3 to 5 carbon atoms (preferably, 3 to 4 carbon atoms; more preferably, 3 carbon atoms); wherein x is 2 to 4 (preferably, 4); wherein y is 6 to 25 (preferably, 7 to 20; more preferably, 8 to 15; most preferably, 8 to 14); wherein z is 1 to 50 (preferably, 4 to 40; more preferably, 6 to 30; most preferably, 8 to 25); and a cleaning booster of Formula (II)

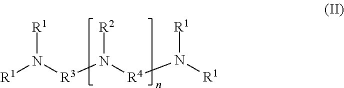

wherein each R¹ is independently a chain of Formula (III)

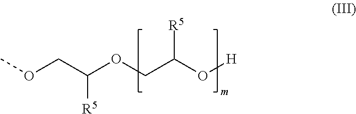

wherein each R² is independently selected from the group consisting of a C₁₋₈ alkyl group and a chain of Formula (III); wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein in is an average of 5 to 50; and wherein the cleaning booster has a weight average molecular weight of ≤10,000 Daltons; and wherein the liquid laundry detergent formulation has a pH of 6.5 to 11; exhibit exceptional detergency for cleaning water temperatures of ≤15° C. (preferably, ≤10° C.).

Unless otherwise indicated, ratios, percentages, parts, and the like are by weight.

As used herein, unless otherwise indicated, the phrase “molecular weight” or Mw refers to the weight average molecular weight as measured in a conventional manner with gel permeation chromatography (GPC) and conventional standards, such as polystyrene molecular weight standards. GPC techniques are discussed in detail in Modern Size-Exclusion Liquid Chromatography—Practice of Gel Permeation and Gel Filtration Chromatography, Second Edition, A. M. Striegel, W. W. Yau, J. J. Kirkland, D. D. Bly; John Wiley & Sons, Inc. 2009. Molecular weights are reported herein in units of Daltons, or equivalently, g/mol.

The term “low temperature detergency stability” as used herein and in the appended claims means that the soil removal index (SRI), calculated using ASTM Method D4265-14, for a given laundry detergent formulation at a wash temperature of 10° C. is at least 95% (preferably, at least 97%; more preferably, at least 98%; most preferably, at least 100%) of the soil removal index (SRI), calculated using ASTM Method D4265-14, for the same laundry detergent formulation at a wash temperature of 30° C.

Preferably, the liquid laundry detergent formulation of the present invention, comprises a synergistic low temperature detergency blend, comprising: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof (preferably, wherein the anionic surfactant is selected from the group consisting of C₈₋₂₀ alkyl benzene sulfates, C₈₋₂₀ alkyl benzene sulfonic acids, C₈₋₂₀ alkyl benzene sulfonates, C₈₋₂₀ alkyl polyethoxy sulfates, paraffin sulfonic acids, paraffin sulfonates, alpha-olefin sulfonic acids, alpha-olefin sulfonates, sulfonates of fatty acids, sulfonates of fatty acid esters, oleic acid and mixtures thereof; more preferably, wherein the anionic surfactant is selected from the group consisting of C₁₂₋₁₆ alkyl benzene sulfonic acids, C₁₂₋₁₆ alkyl benzene sulfonates, C₁₂₋₁₆ alkyl polyethoxy sulfates. C₁₂₋₁₈ paraffin-sulfonic acids. C₁₂₋₁₈ paraffin-sulfonates, oleic acid and mixtures thereof; still more preferably, wherein the anionic surfactant is selected from the group consisting of C₁₂₋₁₆ alkyl benzene sulfonic acids, C₁₂₋₁₆ alkyl benzene sulfonates, C₁₂₋₁₆ alkyl polyethoxy sulfates, oleic acid and mixtures thereof; yet more preferably, wherein the anionic surfactant includes a mixture of dodecyl benzene sulfonic acid, sodium laureth-2 sulfate and oleic acid; most preferably, wherein the anionic surfactant is a mixture of dodecyl benzene sulfonic acid, sodium laureth-2 sulfate and oleic acid); (b) a nonionic surfactant selected from the group of nonionic surfactants having formula (I)

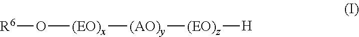

wherein R⁶ is a linear C₈₋₁₈ alkyl group (preferably, a linear C₁₀₋₁₈ alkyl group; more preferably, a linear C₁₂₋₁₄ alkyl group or a linear C₁₆₋₁₈ alkyl group); wherein AO is an oxyalkylene group with 3 to 5 carbon atoms (preferably, 3 to 4 carbon atoms; more preferably, 3 carbon atoms); wherein x is 2 to 4 (preferably, 4); wherein y is 6 to 25 (preferably, 7 to 20; more preferably, 8 to 15; most preferably, 8 to 14); wherein z is 1 to 50 (preferably, 4 to 40; more preferably, 6 to 30; most preferably, 8 to 25); and (c) a cleaning booster of Formula (II)

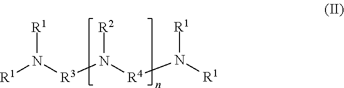

wherein each R¹ is independently a chain of Formula (III)

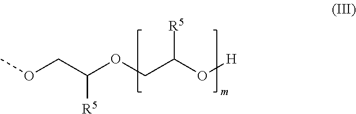

wherein each R² is independently selected from the group consisting of a C₁₋₈ alkyl group and a chain of Formula (III)(preferably, a C₁₋₄ alkyl group and a chain of formula (III); more preferably, a C₁₂ alkyl group and a chain of formula (III); most preferably, a methyl group); wherein R³ and R⁴ are independently an aliphatic C₃₋₁₂ alkanediyl group (preferably, an aliphatic C₃₋₈ alkanediyl group: more preferably, an aliphatic C₃₋₄ alkanediyl group; most preferably, a —CH₂CH₂CH₂— group)(preferably, wherein R³ and R⁴ may be the same or different)(preferably, wherein the aliphatic C₃₋₁₂ alkanediyl groups can be linear or branched and can contain alicyclic groups); wherein each R⁵ is independently selected from the group consisting of a hydrogen and a —C₁₋₄ alkyl group (preferably, a hydrogen and a —C₁₋₃ alkyl group; more preferably, a hydrogen and a —C₁₋₂ alkyl group; most preferably, a hydrogen and a methyl group)(preferably, wherein the R⁵ moieties vary across the molecule with the different R⁵ moieties being randomly dispersed across the molecule or distributed in blocks along the molecule); wherein n is an average of 0 to 8 (preferably, 1 to 8; more preferably, 1 to 4; still more preferably, 1 to 2; most preferably, 1); and wherein n is an average of 5 to 50; and wherein the cleaning booster has a weight average molecular weight of ≤10,000 Daltons (preferably, 1,139 to 10,000 Daltons; more preferably; 1,750 to 5,000 Daltons; most preferably, 2,000 to 4,000 Daltons); and wherein the liquid laundry detergent formulation has a pH of 6.5 to 11 (preferably, 7.5 to 10)(preferably, wherein the liquid laundry detergent formulation further comprises water)(preferably, wherein the formulated laundry detergent formulation comprises 5 to 95 wt % (preferably, 10 to 80 wt %; more preferably, 15 to 75 wt %; still more preferably, 17 to 65 wt %; yet more preferably, 50 to 65 wt %; most preferably, 55 to 60 wt %), based on weight of the liquid laundry detergent formulation, of the anionic surfactant (a) plus the nonionic surfactant (b))(preferably, wherein the liquid laundry detergent formulation comprises 15 to 60 wt % (preferably, 20 to 60 wt %; more preferably, 25 to 50 wt %; most preferably, 25 to 45 wt %), based on the combined weight of the anionic surfactant (a) and the nonionic surfactant (b), of the nonionic surfactant (b)).

Preferably, the cleaning booster of formula (II) used in the synergistic low temperature detergency blend, of the present invention, contains 90 to 99.5 wt % (more preferably, 94 to 99 wt %: more preferably, 95 to 98.5 wt %), based on weight of the cleaning booster, of alkoxide groups. More preferably, the cleaning booster of formula (II) used in the synergistic low temperature detergency blend, of the present invention, contains 90 to 99.5 wt % (more preferably, 94 to 99 wt %; more preferably, 95 to 98.5 wt %), based on weight of the cleaning booster, of alkoxide groups; wherein the alkoxide groups are selected from the group consisting of —CH₂CH₂O— groups, —CH₂CH(CH₃)O— groups and a —CH₂CH(CH₂CH₃)O— groups. Yet more preferably, the cleaning booster of formula (II) used in the synergistic low temperature detergency blend, of the present invention, contains 90 to 99.5 wt % (more preferably, 94 to 99 wt %; more preferably, 95 to 98.5 wt %), based on weight of the cleaning booster, of alkoxide groups; wherein the alkoxide groups are selected from the group consisting of —CH₂CH₂O— groups (i.e., wherein R⁵ in Formula (III) is a hydrogen) and —CH₂CH(CH₃)O— groups (i.e., wherein R⁵ is a methyl group). Most preferably, the cleaning booster of formula (II) used in the synergistic low temperature detergency blend, of the present invention, contains 90 to 99.5 wt % (more preferably, 94 to 99 wt %; more preferably, 95 to 98.5 wt %), based on weight of the cleaning booster, of alkoxide groups; wherein the alkoxide groups are selected from the group consisting of —CH₂CH₂O— groups (i.e., wherein R⁵ in Formula (III) is a hydrogen) and —CH₂CH(CH₃)O— groups (i.e., wherein R⁵ is a methyl group); wherein ≤70 wt % (preferably, 10 to 65 wt %; more preferably, 25 to 60 wt %) of the alkoxide groups are —CH₂CH(CH₃)O— groups. Preferably, the molar ratio of —CH₂CH₂O— groups to —CH₂CH(CH₃)O— groups in the cleaning booster is >0.9:1.

Preferably, the liquid laundry detergent formulation of the present invention, further comprises a water miscible organic solvent. More preferably, the liquid laundry detergent formulation of the present invention, further comprises 0 to 40 wt % (preferably. 2 to 40 wt % (more preferably, 4 to 35 wt %; still more preferably, 5 to 30 wt %; most preferably, 5 to 25 wt %)), based on weight of the liquid laundry detergent formulation, of a water miscible organic solvent. Most preferably, the liquid laundry detergent formulation of the present invention, further comprises 0 to 40 wt % (preferably. 2 to 40 wt % (more preferably, 4 to 35 wt %; still more preferably, 5 to 30 wt %; most preferably, 5 to 25 wt %)), based on weight of the liquid laundry detergent formulation, of a water miscible organic solvent; wherein the water miscible organic solvent is selected from the group consisting of C₁₋₄ alcohol with one hydroxyl group (e.g., ethanol); propylene glycol; glycerol; 1,3-butanediol; 1,3-hexanediol; dipropylene glycol and mixtures thereof (preferably, ethanol, propylene glycol and mixtures thereof; more preferably, propylene glycol).

Preferably, the liquid laundry detergent formulation, of the present, optionally further comprises an optional additive selected from the group consisting of builders (e.g., sodium bicarbonate, sodium carbonate, zeolites, sodium citrate, sodium tripolyphosphate and aminocarboxylates (such as methylglycine diacetic acid, sodium salt or glutamic acid diacetic acid, sodium salt)); hydrotropes (e.g., sodium xylene sulfonate, sodium cumene sulfonate, sodium toluene sulfonate): foam control agents (e.g., polydimethylsiloxane): enzymes (e.g., protease, cellulases, lipase, amylase, mannanases); preservatives; fragrances (e.g., essential oils such as D-limonene); fluorescent whitening agents; bleach (e.g., sodium percarbonate, sodium perborate, sodium hypochlorite); dyes; additive polymers (e.g., dispersant polymers such as acrylic acid homopolymers and copolymers of acrylic acid with maleic acid, sulfonated monomer and/or ethyl acrylate); fabric softeners (e.g., softening silicones, cationic coacervating polymers (e.g., cationic hydroxyalkyl cellulose, polyquaternium polymers)); pH adjusters/buffers and mixtures thereof.

Preferably, the use of a liquid laundry detergent formulation comprising a synergistic low temperature detergency blend for cleaning fabrics under cold wash conditions (preferably, at wash temperatures of ≤15° C.; more preferably, at wash temperatures of ≤10° C.); wherein the synergisting low temperature detergency blend of the present invention comprises: (a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid, salts thereof and mixtures thereof (preferably, wherein the anionic surfactant is selected from the group consisting of C₈₋₂₀ alkyl benzene sulfates, C₈₋₂₀ alkyl benzene sulfonic acids, C₈₋₂₀ alkyl benzene sulfonates, C₈₋₂₀ alkyl polyethoxy sulfates, paraffin sulfonic acids, paraffin sulfonates, alpha-olefin sulfonic acids, alpha-olefin sulfonates, sulfonates of fatty acids, sulfonates of fatty acid esters, oleic acid and mixtures thereof; more preferably, wherein the anionic surfactant is selected from the group consisting of C₁₂₋₁₆ alkyl benzene sulfonic acids, C₁₂₋₁₆ alkyl benzene sulfonates, C₁₂₋₁₆ alkyl polyethoxy sulfates, C₁₂₋₁₈ paraffin-sulfonic acids, C₁₂₋₁₈ paraffin-sulfonates, oleic acid and mixtures thereof; still more preferably, wherein the anionic surfactant is selected from the group consisting of C₁₂₋₁₆ alkyl benzene sulfonic acids, C₁₂₋₁₆ alkyl benzene sulfonates, C₁₂₋₁₆ alkyl polyethoxy sulfates, oleic acid and mixtures thereof; yet more preferably, wherein the anionic surfactant includes a mixture of dodecyl benzene sulfonic acid, sodium laureth-2 sulfate and oleic acid; most preferably, wherein the anionic surfactant is a mixture of dodecyl benzene sulfonic acid, sodium laureth-2 sulfate and oleic acid): (b) a nonionic surfactant selected from the group of nonionic surfactants having formula (I)

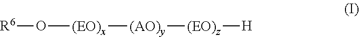

wherein R⁶ is a linear C₈₋₁₈ alkyl group (preferably, a linear C₁₀₋₁₈ alkyl group; more preferably, a linear C₁₂₋₁₄ alkyl group or a linear C₁₆₋₁₈ alkyl group); wherein AO is an oxyalkylene group with 3 to 5 carbon atoms (preferably, 3 to 4 carbon atoms; more preferably, 3 carbon atoms); wherein x is 2 to 4 (preferably, 4); wherein y is 6 to 25 (preferably, 7 to 20; more preferably, 8 to 15; most preferably, 8 to 14); wherein z is 1 to 50 (preferably, 4 to 40: more preferably, 6 to 30; most preferably, 8 to 25); and (c) a cleaning booster of Formula (II)

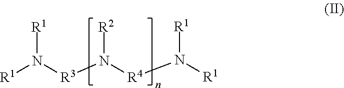

wherein each R¹ is independently a chain of Formula (III)

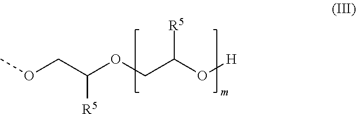

wherein each R² is independently selected from the group consisting of a C₁₋₈ alkyl group and a chain of Formula (III)(preferably, a C₁₋₄ alkyl group and a chain of formula (III); more preferably, a C₁₋₂ alkyl group and a chain of formula (III); most preferably, a methyl group); wherein R³ and R⁴ are independently an aliphatic C₃₋₁₂ alkanediyl group (preferably, an aliphatic C₃₋₈ alkanediyl group; more preferably, an aliphatic C₃₋₄ alkanediyl group; most preferably, a —CH₂CH₂CH₂— group)(preferably, wherein R³ and R⁴ may be the same or different)(preferably, wherein the aliphatic C₃₋₁₂ alkanediyl groups can be linear or branched and can contain alicyclic groups); wherein each R⁵ is independently selected from the group consisting of a hydrogen and a —C₁₋₄ alkyl group (preferably, a hydrogen and a —C₁₋₃ alkyl group; more preferably, a hydrogen and a —C₁₋₂ alkyl group; most preferably, a hydrogen and a methyl group)(preferably, wherein the R⁵ moieties vary across the molecule with the different R⁵ moieties being randomly dispersed across the molecule or distributed in blocks along the molecule); wherein n is an average of 0 to 8 (preferably, 1 to 8; more preferably, 1 to 4; still more preferably, 1 to 2; most preferably, 1); and wherein m is an average of 5 to 50; and wherein the cleaning booster has a weight average molecular weight of ≤10,000 Daltons (preferably, 1,139 to 10,000 Daltons: more preferably: 1.750 to 5,000 Daltons; most preferably, 2,000 to 4,000 Daltons); and wherein the liquid laundry detergent formulation has a pH of 6.5 to 11 (preferably, 7.5 to 10)(preferably, wherein the liquid laundry detergent formulation further comprises water)(preferably, wherein the formulated laundry detergent formulation comprises 5 to 95 wt % (preferably, 10 to 80 wt %; still more preferably, 17 to 65 wt %; yet more preferably, 50 to 65 wt %; most preferably, 55 to 60 wt %), based on weight of the liquid laundry detergent formulation, of the anionic surfactant (a) plus the nonionic surfactant (b))(preferably, wherein the liquid laundry detergent formulation comprises 15 to 60 wt % (preferably, 20 to 60 wt %; more preferably. 25 to 50 wt %; most preferably, 25 to 45 wt %), based on the combined weight of the anionic surfactant (a) and the nonionic surfactant (b), of the nonionic surfactant (b)).

Preferably, the method of washing a fabric article of the present invention, comprises: providing a soiled fabric article (preferably, wherein the soiled fabric article is soiled with oil and grease borne soil; more preferably, wherein the soiled fabric article is soiled with sebum oils)(preferably, wherein the soiled fabric article is stained cotton fabric: more preferably, wherein the soiled fabric article is stained polycotton fabric); providing a liquid laudry detergent formulation of the present invention comprising a synergistic low temperature detergency blend; providing a wash water at a temperature of ≤15° C. (preferably, ≤10° C.); and applying the wash water and the liquid laundry detergent formulation to the soiled fabric article to provide a cleaned fabric article. More preferably, the method of washing a fabric article of the present invention, comprises: providing a soiled fabric article (preferably, wherein the soiled fabric article is soiled with oil and grease borne soil; more preferably, wherein the soiled fabric article is soiled with sebum oils)(preferably, wherein the soiled fabric article is stained cotton fabric; more preferably, wherein the soiled fabric article is stained polycotton fabric); providing a liquid laudry detergent formulation of the present invention comprising a synergistic low temperature detergency blend; providing a wash water at a temperature of ≤15° C. (preferably, ≤10° C.); providing a rinse water; applying the wash water and the liquid laundry detergent formulation to the soiled fabric to provide a cleaned fabric article; and then applying the rinse water to the cleaned fabric article to remove the formulated laundry detergent formulation from the cleaned fabric article.

Some embodiments of the present invention will now be described in detail in the following Examples.

### Synthesis S1: L-C₁₂₋₁₄-(EO)₄-(PO)₈-(EO)₁₂

A nonionic surfactant represented by the formula L-C₁₂₋₁₄-(EO)₄-(PO)₈-(EO)₁₂ was prepared, wherein “L-C₁₂₋₁₄” is a linear C₁₂₋₁₄ alkyl moiety. One mole of L-C₁₂₋₁₄ alcohol and a 45-50 wt % aqueous solution of potassium hydroxide were charged to a reactor. The potassium hydroxide charge was sufficient to provide a KOH concentration of 0.17 wt %, based on weight of the polymer product. The contents of the reactor were maintained at 50 to 60° C. for thirty minutes. The moisture content in the vapor space of the reactor was then reduced to less than 1,000 ppm by vacuum stripping at 80° C. The temperature set point for the reactor contents was then raised to 110° C. Then four molar equivalents of ethylene oxide. EO, based on the initial charge of L-C₁₂₋₁₄ alcohol, was fed to the reactor slowly while the temperature of the reactor contents was maintained at 110 to 140° C. When the pressure in the reactor returned to approximately the same as the pressure prior to feeding the EO, eight molar equivalents of propylene oxide, PO, based on the initial charge of L-C₁₂₋₁₄ alcohol, was fed to the reactor slowly while the temperature of the reactor contents was maintained at 110 to 140° C. When the pressure in the reactor returned to approximately the same as the pressure prior to feeding the PO, twelve molar equivalents of EO, based on the initial charge of L-C₁₂₋₁₄ alcohol, was fed to the reactor slowly while the temperature of the reactor contents was maintained at 110 to 140° C. When the pressure in the reactor returned to approximately the same pressure as before feeding the EO, the reactor contents were maintained at 110 to 140° C. for two more hours to facilitate full reaction of the EO. The reactor was then purged with nitrogen and the reactor contents were cooled down to 60° C. Then acetic acid was added to the reactor contents to neutralize the potassium hydroxide. After the reactor contents cooled down to 40° C. the product polymer was recovered.

### Syntheses S2-S9

The procedure described in Synthesis S1 was repeated in Syntheses S2-S9 wherein the alcohol used had an alkyl group as noted in TABLE 1 and the relative molar amounts of EO and PO added in the various steps as noted in TABLE 1.

TABLE 1

| | | Alkylene Oxide Blocks (mols) | | | |
|---|---|---|---|---|---|
| Ex. | R | 1^{st} EO Block | PO Block | 2^{nd} EO Block | Generic Structure |
| S1 | L-C₁₂₋₁₄ | 4 | 8 | 12 | L-C₁₂₋₁₄-(EO)₄(PO)₈(EO)₁₂ |
| S2 | L-C₁₂₋₁₄ | 4 | 12 | 14 | L-C₁₂₋₁₄-(EO)₄(PO)₁₂(EO)₁₄ |
| S3 | L-C₁₆₋₁₈ | 4 | 14 | 15 | L-C₁₆₋₁₈-(EO)₄(PO)₁₄(EO)₁₅ |
| S4 | L-C₁₆₋₁₈ | 4 | 14 | 25 | L-C₁₆₋₁₈-(EO)₄(PO)₁₄(EO)₂₅ |
| S5 | L-C₁₂₋₁₄ | 9 | 0 | 0 | L-C₁₂₋₁₄-(EO)₉ |
| S6 | B-C₈ | 0 | 5 | 9 | B-C₈-(PO)₅-(EO)₉ |
| S7 | L-C₁₂₋₁₄ | 4 | 8 | 8 | L-C₁₂₋₁₄-(EO)₄(PO)₈(EO)₈ |
| S8 | L-C₁₂₋₁₄ | 4 | 8 | 10 | L-C₁₂₋₁₄-(EO)₄(PO)₈(EO)₁₀ |
| S9 | L-C₁₂₋₁₄ | 4 | 12 | 8 | L-C₁₂₋₁₄-(EO)₄-(PO)₁₂-(EO)₈ |

*L-alkyl group is a linear alcohol (R—OH) wherein R is a linear alkyl group with listed number carbons and the hydroxyl (—OH) group is bound to a primary carbon atom at the end of the alkyl chain.
B-alkyl group is a branched alcohol (R—OH) wherein R is a branched alkyl group with the listed number of carbons and the hydroxyl (—OH) group is bound to a primary carbon atom at the end of a branched alkyl chain.

### Synthesis S10: Cleaning Booster

A cleaning booster was prepared using a pressure reactor. Propylene oxide (PO) and ethylene oxide (EO) were separately delivered using ISCO syringe pumps equipped with a robotically controlled needle and compressed gas micro valve. The pressure reactor was outfitted with a glass insert and a removable stir paddle. The reactor was initially dried in a vacuum oven at 125° C.

Bis(3-aminopropyl)methylamine (14.5 g) and propylene oxide (17 g) were mixed in an autoclage and stirred at 140° C. for 8 hours. The obtained material was mixed with aqueous KOH (4 g, 45 wt % KOH) with subsequent water removal. This mixture was propoxylated with propylene oxide (27.7 g) at 115° C. for 24 hours to form an intermediate with the approximate composition (diamine)(PO)₈.

The obtained intermediate (diamine)(PO)₈ containing about 3 wt % KOH (0.567 mL) was charged to the reactor under nitrogen. The reactor was then sealed and charged with propylene oxide (1.496 mL). The temperature was increased to 115° C. and the reaction mixture was stirred for 24 hours after reaching the process temperature. The reactor pressure were observed to decrease and gradually level off by the end of the heating period indicating that the reaction was completed. The reactor was cooled, vented, and purged with nitrogen. Then the reactor was heated to 130° C. and ethylene oxide (1.684 mL) was added to the reactor contents. The reactor contents were stirred at 130° C. for 4 hours. A pressure curve showed the reaction completion. The synthesis produced a sample having a 33.7/32.7 mol/mol PO/EO ratio. After cooling, venting and purging the reactor with nitrogen, a small sample was taken from the reactor for NMR and GPC analysis, with results in TABLE 2.

TABLE 2

| | mol/mol (diamine)(PO)₈ | | wt % | | Daltons | |
|---|---|---|---|---|---|---|
| Ex. | EO | PO | EO | PO | Mw | Mn |
| S10 | 32.7 | 33.7 | 40.6 | 55.3 | 3,109 | 2,387 |

### Comparative Examples CF1-CF8 and Examples F1-F4: Concentrated Detergent

The concentrated laundry detergent formulations of Comparative Examples CF1-CF8 and Examples F1-F4 used in the cleaning tests in subsequent Examples were prepared having the generic formulation as described in TABLE 3. The water and propylene glycol were mixed in a beaker with mechanical stirring. The dodecylbenzene sulfonic acid, sodium laureth-2 sulfate, oleic acid and potassium hydroxide were then added in the beaker with continued stirring. The nonionic surfactant (Synthesis S1-S6 or Lutensol® XL-80) was then added to the beaker with continued stirring. The pH was then adjusted to 8 to 8.5 with potassium hydroxide to form the concentrated laundry detergent.

### Comparative Examples CF9-CF18 and Examples F5-F10: Standard Laundry Detergent

The standard laundry detergent formulations of Comparative Examples CF9-CF8 and Examples F5-F10 used in the cleaning tests in subsequent Examples were prepared having the formulation as described in TABLE 4. The water, dodecylbenzene sulfonic acid, sodium laureth-2 sulfate, oleic acid and sodium hydroxide were then added in the beaker with continued stirring. The nonionic surfactant (Synthesis S1, S3-S9 or Lutensol® XL-80) and cleaning booster, if any, was then added to the beaker with continued stirring. The pH was then adjusted to 8 to 8.5 with potassium hydroxide to form the standard laundry detergent.

### Comparative Examples CF19-CF27 and Examples F11-F15: Unit Dose Detergent

The unit dose laundry detergent formulations of Comparative Examples CF19-CF27 and Examples F11-F15 used in the cleaning tests in subsequent Examples were prepared having the formulation as described in TABLE 5. The water and propylene glycol were mixed in a beaker with mechanical stirring. The dodecylbenzene sulfonic acid, ammonium laureth-2 sulfate, oleic acid and monoethanol amine were then added in the beaker with continued stirring. The nonionic surfactant (Synthesis S1-S6 or Lutensol© XL-80) was then added to the beaker with continued stirring. The pH was then adjusted to 7.5 with monoethanol amine to form the concentrated laundry detergent.

### Low Temperature Detergency

The low temperature detergency, LTD, of the laundry detergent formulations of Comparative Examples CF1-CF27 and Examples F1-F15 was assessed in a Terg-o-tometer Model TOM-52-A available from SR Lab Instruments (6×1 L wells) agitated at 120 cycles per minute with the conditions noted below.

| Parameter | Setting |
|---|---|
| Temperature | 10° C. |
| Water hardness | 250 ppm, Ca²/Mg²⁺ = 2.04/1.67 |
| Fabric Types | JB003 Sebum Cloth |
| (3 in each well) | |
| Stains | Synthetic sebum, gum, pigment (from China |
| | Research Institute of Daily Chemical |
| | Industry) |
| Wash time | 20 minutes |
| Rinse time | 2 minutes |
| Liquid laundry detergent | 0.8 g/L (conc. and unit dose detergents) |
| dosage | 2 g/L (standard laundry detergent) |

The soil removal (in %) was calculated for each of the laundry detergent formulations of Comparative Examples CF1-CF27 and Examples F1-F15 using the following formula:

$$SR ( \% ) = [ ( {L}_{A}^{*} - {L}_{B}^{*} ) / ( 96 - {L}_{B}^{*} ) ] \times 100 \%$$

wherein SR (%) is the calculated soil removal in %; wherein L*_{A} is the L* value for a dry fabric swatch measured by spectrophotometer (Konica Minolta Spectrophotometer CM-3600A) after washing; and wherein L*_{B} is the L* value for a dry fabric swatch measured by spectrophotometer before washing. The results are provided in TABLES 3-5.

TABLE 3

| | Examples (wt %) | | | | | | | | | | | |
|---|---|---|---|---|---|---|---|---|---|---|---|---|
| Ingredient | CF1 | CF2 | CF3 | CF4 | CF5 | CF6 | CF7 | CF8 | F1 | F2 | F3 | F4 |
| Oleic acid | 5.0 | 5.0 | 5.0 | 5.0 | 5.0 | 5.0 | 5.0 | 5.0 | 5.0 | 5.0 | 5.0 | 5.0 |
| Dodecylbenzene | 11.0 | 11.0 | 11.0 | 11.0 | 11.0 | 11.0 | 11.0 | 11.0 | 11.0 | 11.0 | 11.0 | 11.0 |
| sulfonic acid | | | | | | | | | | | | |
| Sodium laureth-2 | 12.0 | 12.0 | 12.0 | 12.0 | 12.0 | 12.0 | 12.0 | 12.0 | 12.0 | 12.0 | 12.0 | 12.0 |
| sulfate | | | | | | | | | | | | |
| Synthesis S1 | 24.0 | — | — | — | — | — | — | — | 20.0 | — | — | — |
| Synthesis S2 | — | 24.0 | — | — | — | — | — | — | — | 20.0 | — | — |
| Synthesis S3 | — | — | 24.0 | — | — | — | — | — | — | — | 20.0 | — |
| Synthesis S4 | — | — | — | 24.0 | — | — | — | — | — | — | — | 20.0 |
| Synthesis S5 | — | — | — | — | 24.0 | 20.0 | — | — | — | — | — | — |
| Synthesis S6 | — | — | — | — | — | — | 20.0 | — | — | — | — | — |
| Branched C₁₀- | — | — | — | — | — | — | — | 20.0 | — | — | — | — |
| (PO)₁₋₂-(EO)₈₋₉* | | | | | | | | | | | | |
| Synthesis S10 | — | — | — | — | — | 4.0 | 4.0 | 4.0 | 4.0 | 4.0 | 4.0 | 4.0 |
| Propylene glycol | 6.0 | 6.0 | 6.0 | 6.0 | 6.0 | 6.0 | 6.0 | 6.0 | 6.0 | 6.0 | 6.0 | 6.0 |
| Potassium Hydroxide | 3.2 | 3.2 | 3.2 | 3.2 | 3.2 | 3.2 | 3.2 | 3.2 | 3.2 | 3.2 | 3.2 | 3.2 |
| Deionized water | 38.8 | 38.8 | 38.8 | 38.8 | 38.8 | 38.8 | 38.8 | 38.8 | 38.8 | 38.8 | 38.8 | 38.8 |
| Total wt % surfactants | 52.0 | 52.0 | 52.0 | 52.0 | 52.0 | 48.0 | 48.0 | 48.0 | 48.0 | 48.0 | 48.0 | 48.0 |
| % of surfactants-nonionic | 46.2 | 46.2 | 46.2 | 46.2 | 46.2 | 41.7 | 41.7 | 41.7 | 41.7 | 41.7 | 41.7 | 41.7 |
| SR % at 10° C. | 14.5 | 15.3 | 16.4 | 16.3 | 14.6 | 15.8 | 13.8 | 13.8 | 16.7 | 16.4 | 17.1 | 17.6 |

*LUTENSOL ® XL 80 C₁₀ Guerbet alcohol alkoxylate from BASF Corporation

TABLE 4

| | Examples (wt %) | | | | | | | |
|---|---|---|---|---|---|---|---|---|
| Ingredient | CF9 | CF10 | CF11 | CF12 | CF13 | CF14 | CF15 | CF16 |
| Oleic acid | 1.5 | 1.5 | 1.5 | 1.5 | 1.5 | 1.5 | 1.5 | 1.5 |
| Dodecyl | 8.0 | 8.0 | 8.0 | 8.0 | 8.0 | 8.0 | 8.0 | 8.0 |
| benzene | | | | | | | | |
| sulfonic | | | | | | | | |
| acid | | | | | | | | |
| Sodium | 5.0 | 5.0 | 5.0 | 5.0 | 5.0 | 5.0 | 5.0 | 5.0 |
| laureth-2 | | | | | | | | |
| sulfate | | | | | | | | |
| Syn. S1 | 7.0 | — | 7.0 | — | — | — | — | — |
| Syn. S3 | — | — | — | — | 7.0 | — | — | — |
| Syn. S4 | — | — | — | — | — | 7.0 | — | — |
| Syn. S5 | — | — | — | — | — | — | 7.0 | 5.0 |
| Syn. S6 | — | — | — | — | — | — | — | — |
| Syn. S7 | — | — | — | — | — | — | — | — |
| Syn. S8 | — | 7.0 | — | — | — | — | — | — |
| Syn. S9 | — | — | — | 7.0 | — | — | — | — |
| Branched | — | — | — | — | — | — | — | — |
| C₁₀-(PO)₁₋₂- | | | | | | | | |
| (EO)₈₋₉ | | | | | | | | |
| Syn. S10 | — | — | — | — | — | — | — | 2.0 |
| NaOH | 1.2 | 1.2 | 1.2 | 1.2 | 1.2 | 1.2 | 1.2 | 1.2 |
| DI water | 77.3 | 77.3 | 77.3 | 77.3 | 77.3 | 77.3 | 77.3 | 77.3 |
| Total wt % | 21.5 | 21.5 | 21.5 | 21.5 | 21.5 | 21.5 | 21.5 | 19.5 |
| surfactants | | | | | | | | |
| % of | 32.6 | 32.6 | 32.6 | 32.6 | 32.6 | 32.6 | 32.6 | 25.6 |
| surfactants- | | | | | | | | |
| nonionic | | | | | | | | |
| SR % at | 17.9 | 18.8 | 18.3 | 19.1 | 19.9 | 20.5 | 15.7 | 18.7 |
| 10° C. | | | | | | | | |
| | Examples (wt %) | | | | | | | |
| Ingredient | CF17 | CF18 | F5 | F6 | F7 | F8 | F9 | F10 |
| Oleic acid | 1.5 | 1.5 | 1.5 | 1.5 | 1.5 | 1.5 | 1.5 | 1.5 |
| Dodecyl | 8.0 | 8.0 | 8.0 | 8.0 | 8.0 | 8.0 | 8.0 | 8.0 |
| benzene | | | | | | | | |
| sulfonic | | | | | | | | |
| acid | | | | | | | | |
| Sodium | 5.0 | 5.0 | 5.0 | 5.0 | 5.0 | 5.0 | 5.0 | 5.0 |
| laureth-2 | | | | | | | | |
| sulfate | | | | | | | | |
| Syn. S1 | — | — | — | — | 5.0 | — | — | — |
| Syn. S3 | — | — | — | — | — | — | 5.0 | — |
| Syn. S4 | — | — | — | — | — | — | — | 5.0 |
| Syn. S5 | — | — | — | — | — | — | — | — |
| Syn. S6 | 5.0 | — | — | — | — | — | — | — |
| Syn. S7 | — | — | 5.0 | — | — | — | — | — |
| Syn. S8 | — | — | — | 5.0 | — | — | — | — |
| Syn. S9 | — | — | — | — | — | 5.0 | — | — |
| Branched | — | 5.0 | — | — | — | — | — | — |
| C₁₀-(PO)₁₋₂- | | | | | | | | |
| (EO)₈₋₉ | | | | | | | | |
| Syn. S10 | 2.0 | 2.0 | 2.0 | 2.0 | 2.0 | 2.0 | 2.0 | 2.0 |
| NaOH | 1.2 | 1.2 | 1.2 | 1.2 | 1.2 | 1.2 | 1.2 | 1.2 |
| DI water | 77.3 | 77.3 | 77.3 | 77.3 | 77.3 | 77.3 | 77.3 | 77.3 |
| Total wt % | 19.5 | 19.5 | 19.5 | 19.5 | 19.5 | 19.5 | 19.5 | 19.5 |
| surfactants | | | | | | | | |
| % of | 25.6 | 25.6 | 25.6 | 25.6 | 25.6 | 25.6 | 25.6 | 25.6 |
| surfactants- | | | | | | | | |
| nonionic | | | | | | | | |
| SR % at | 15.7 | 16.8 | 19.7 | 19.5 | 20.2 | 20.4 | 21.1 | 21.9 |
| 10° C. | | | | | | | | |

*LUTENSOL ® XL 80 C₁₀ Guerbet alcohol alkoxylate from BASF Corporation

TABLE 5

| | Examples (wt %) | | | | | | | | | | | | | |
|---|---|---|---|---|---|---|---|---|---|---|---|---|---|---|
| Ingredient | CF19 | CF20 | CF21 | CF22 | CF23 | CF24 | CF25 | CF26 | CF27 | F11 | F12 | F13 | F14 | F15 |
| Oleic acid | 10.0 | 10.0 | 10.0 | 10.0 | 10.0 | 10.0 | 10.0 | 10.0 | 10.0 | 10.0 | 10.0 | 10.0 | 10.0 | 10.0 |
| Dodecyl | 20.0 | 20.0 | 20.0 | 20.0 | 20.0 | 20.0 | 20.0 | 20.0 | 20.0 | 20.0 | 20.0 | 20.0 | 20.0 | 20.0 |
| benzene | | | | | | | | | | | | | | |
| sulfonic acid | | | | | | | | | | | | | | |
| Sodium | 8.75 | 8.75 | 8.75 | 8.75 | 8.75 | 8.75 | 8.75 | 8.75 | 8.75 | 8.75 | 8.75 | 8.75 | 8.75 | 8.75 |
| laureth-2 | | | | | | | | | | | | | | |
| sulfate | | | | | | | | | | | | | | |
| Syn. S1 | — | — | 25.0 | — | — | — | — | — | — | — | — | 20.0 | — | — |
| Syn. S3 | — | — | — | — | 25.0 | — | — | — | — | — | — | — | — | 20.0 |
| Syn. S5 | — | — | — | — | — | 25.0 | 20.0 | — | — | — | — | — | — | — |
| Syn. S6 | — | — | — | — | — | — | — | 20.0 | — | — | — | — | — | — |
| Syn. S7 | 25.0 | — | — | — | — | — | — | — | — | 20.0 | — | — | — | — |
| Syn. S8 | — | 25.0 | — | — | — | — | — | — | — | — | 20.0 | — | — | — |
| Syn. S9 | — | — | — | 25.0 | — | — | — | — | — | — | — | — | 20.0 | — |
| Branched C₁₀- | — | — | — | — | — | — | — | — | 20.0 | — | — | — | — | — |
| (PO)₁₋₂-(EO)₈₋₉ | | | | | | | | | | | | | | |
| Syn. S10 | — | — | — | — | — | — | 5.0 | 5.0 | 5.0 | 5.0 | 5.0 | 5.0 | 5.0 | 5.0 |
| Propylene | 23.0 | 23.0 | 23.0 | 23.0 | 23.0 | 23.0 | 23.0 | 23.0 | 23.0 | 23.0 | 23.0 | 23.0 | 23.0 | 23.0 |
| glycol | | | | | | | | | | | | | | |
| Monoethanol | 5.4 | 5.4 | 5.4 | 5.4 | 5.4 | 5.4 | 5.4 | 5.4 | 5.4 | 5.4 | 5.4 | 5.4 | 5.4 | 5.4 |
| amine | | | | | | | | | | | | | | |
| Deionized | 7.85 | 7.85 | 7.85 | 7.85 | 7.85 | 7.85 | 7.85 | 7.85 | 7.85 | 7.85 | 7.85 | 7.85 | 7.85 | 7.85 |
| water | | | | | | | | | | | | | | |
| Total wt % | 63.75 | 63.75 | 63.75 | 63.75 | 63.75 | 63.75 | 58.75 | 58.75 | 58.75 | 58.75 | 58.75 | 58.75 | 58.75 | 58.75 |
| surfactants | | | | | | | | | | | | | | |
| % of | 39.2 | 39.2 | 32.9 | 32.9 | 39.2 | 39.2 | 34.0 | 34.0 | 34.0 | 34.0 | 34.0 | 34.0 | 34.0 | 34.0 |
| surfactants- | | | | | | | | | | | | | | |
| nonionic | | | | | | | | | | | | | | |
| SR% at 10° C. | 20.4 | 20.3 | 20.3 | 20.5 | 22.4 | 14.6 | 17.9 | 15.4 | 16.7 | 22.4 | 21.4 | 22.0 | 22.1 | 24.8 |

*LUTENSOL ® XL 80 C₁₀ Guerbet alcohol alkoxylate from BASF Corporation

We claim:

1. A liquid laundry detergent formulation, comprising a synergistic low temperature detergency blend comprising:
(a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof;
(b) a nonionic surfactant selected from the group of nonionic surfactants having formula (I) 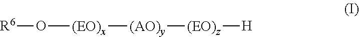
wherein R⁶ is a linear C₈₋₁₈ alkyl group; wherein AO is an oxyalkylene group with 3 to 5 carbon atoms; wherein x is 2 to 4; wherein y is 6 to 25; wherein z is 1 to 50; and
(c) a cleaning booster of Formula (II) 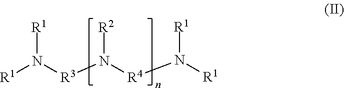
wherein each R¹ is independently a chain of Formula (III) 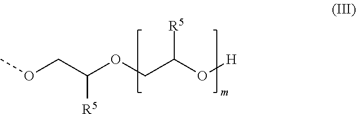
wherein each R² is independently selected from the group consisting of a Cis alkyl group and a chain of Formula (III); wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein m is an average of 5 to 50; and wherein the cleaning booster has a weight average molecular weight of ≤10,000 Daltons; and wherein the liquid laundry detergent formulation has a pH of 6.5 to 11.

2. The liquid laundry detergent formulation of claim 1, further comprising water.

3. The liquid laundry detergent formulation of claim 2, wherein AO is an oxyalkylene group with 3 carbon atoms; wherein the liquid laundry detergent formulation comprises 5 to 95 wt %, based on weight of the liquid laundry detergent formulation, of the anionic surfactant (a) plus the nonionic surfactant (b).

4. The liquid laundry detergent formulation of claim 3, wherein the liquid laundry detergent formulation comprises 15 to 60 wt %, based on the combined weight of the anionic surfactant (a) and the nonionic surfactant (b), of the nonionic surfactant (b).

5. The liquid laundry detergent formulation of claim 6, wherein the liquid laundry detergent formulation further comprises a water miscible organic solvent.

6. The liquid laundry detergent formulation of claim 5, further comprising an optional additive selected from the group consisting of builders: hydrotropes; foam control agents; enzymes; preservatives; fragrances; fluorescent whitening agents; bleach; dyes; additive polymers; fabric softeners; pH adjusters/buffers and mixtures thereof.

7. Use of a liquid laundry detergent formulation comprising a synergistic low temperature detergency blend for cleaning fabrics under cold wash conditions; wherein the synergisting low temperature detergency blend comprises:
(a) an anionic surfactant selected from the group consisting of alkyl sulfates, alkyl benzene sulfates, alkyl benzene sulfonic acids, alkyl benzene sulfonates, alkyl polyethoxy sulfates, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenol polyethoxy ether sulfates, 2-acryloxy-alkane-1-sulfonic acids, 2-acryloxy-alkane-1-sulfonates, beta-alkyloxy alkane sulfonic acids, beta-alkyloxy alkane sulfonates, oleic acid and mixtures thereof;
(b) a nonionic surfactant selected from the group of nonionic surfactants having formula (I) 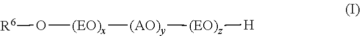
wherein R⁶ is a linear C₈₋₁₈ alkyl group; wherein x is 2 to 4; wherein AO is an oxyalkylene group with 3 to 5 carbon atoms; wherein y is 6 to 25; wherein z is 1 to 50; and wherein the nonionic surfactant is selected based on its ability to impart detergency stability to the laundry detergent formulation for cleaning water temperatures ranging from 10 to 30° C.; and
(c) a cleaning booster of Formula (II) 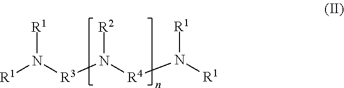
wherein each R¹ is independently a chain of Formula (III) 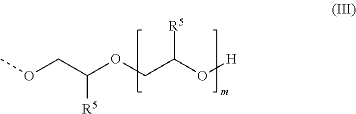
wherein each R² is independently selected from the group consisting of a C₁₋₈ alkyl group and a chain of Formula (III); wherein R³ and R⁴ are independently an aliphatic C₃₋₁₂ alkanediyl group; wherein each R⁵ is independently selected from the group consisting of a hydrogen and a —C₁₋₄ alkyl group; wherein n is an average of 0 to 8; wherein m is an average of 5 to 50; and wherein the cleaning booster has a weight average molecular weight of ≤10,000 Daltons; and wherein the liquid laundry detergent formulation has a pH of 6.5 to 11.

8. A method of washing a fabric article, comprising:
providing a soiled fabric article;
providing a liquid laundry detergent formulation according to claim 1;
providing a wash water at a temperature of ≤15° C.; and
applying the wash water and the liquid laundry detergent formulation to the soiled fabric article to provide a cleaned fabric article.

9. The method of claim 8, wherein the liquid laundry detergent formulation provided is according to claim 5.

10. The method of claim 8, wherein the liquid laundry detergent formulation provided is according to claim 6.
